(19) United States
(12) Patent Application Publication
(10) Pub. No.: US 2011/0207380 A1
(43) Pub. Date: Aug. 25, 2011

(54) Game call tone selector

(76) Inventor: Rockie L. Jacobsen, Kamiah, ID (US)

(21) Appl. No.: 12/660,287

(22) Filed: Feb. 23, 2010

(51) Int. Cl. A01M 31/00; A63H 5/00

(52) U.S. Cl. 446/202; 446/487

(57) ABSTRACT

A game call tone selector that allows the user to change the tone, pitch and volume of a game call. A movable cap is disposed over the rim of a game calls sound chamber. Openings in the cap's lip and the sound chamber's rim may be aligned and fully open, partially aligned and partially open, or unaligned and fully closed, altering the tone, pitch and volume of the call. The game call further discloses a flexible call pipe that may be retracted within a larger bugle tube, thereby providing a game call that is compact, easy to carry, and can be used hands-free while deploying a gun or bow.

### FIELD OF THE INVENTION

The present invention relates generally to game calls and, more specifically, to a device to change the tone, pitch and volume of a game call, as well as a large game call that is compact, easy to carry, and can be used hands-free while deploying a gun or bow.

### BACKGROUND OF THE INVENTION

A number of patents have been issued that disclose game calls with devices intended to change the call's tone, pitch and volume. For example, U.S. Pat. No. 3,772,823 to Herter discloses “a moose call which is designed to produce internal reverberation and emission of extremely low pitched audio frequency sounds simulating the mating call of a moose.” See Herter, col. 1, lines 4 through 7. The Herter patent has a mouthpiece (11) in which a reed (14) is located. Sound exits through the “flared outlet end” (17) and enters an “elongate reverberation tube” (18). At the end of the tube (18) is a “hardwood annular ring” (20) and an “outlet opening” (24), which form a “rearwardly facing sound reflecting shoulder surface” (23). According to Herter, the sound from the mouthpiece is reflected in the tube (18) “by the ring at the outermost end of the tube”, causing the sound to reverberate. See Herter, col. 1, lines 7 through 14. The tube (18) is plastic and can be deformed to change the sound. See Herter, col. 2, lines 4 through 10. One disadvantage of this design is that the deformation of the plastic tube (18) is imprecise, making it difficult for the user to make a consistent call. Also, the single tube design of Herter does not work well to produce large game calls.

Another patent with a sound chamber is U.S. Pat. No. 6,231,417 to Palmer. Palmer discloses a call (100) with a reed assembly (150) that lets sound pass through the “reed exit end” (114) into an “initial sound chamber” (120). The initial sound chamber (120) has a “thick walled portion” (126) leading to a “thin walled portion” (128). Sound leaves the initial sound chamber (120) at an “exit end” (124) through a hole (129) and enters a “back pressure sound chamber” (140). The back pressure sound chamber (140) is described as a “cap” (130) on the end of the call. The cap (130) has a “cap exit end” (134) with a hole (139) forming a “sound exit end” (104). Sound passes through the initial sound chamber sound exit hole (129) and then enters back pressure sound chamber (140), and the “dimensions of back pressure sound chamber 140 and initial sound chamber 142 help determine the sound of the call 100”. See Palmer, col. 3, lines 7 through 9. Comparing Herter and Palmer, Palmer adds a second sound chamber tube (the “back pressure sound chamber 140”), after Herter's “reverberation tube” (18). Palmer explains that the “dimensions of back pressure chamber 140 and initial sound chamber 142 help determine the sound of the call”, and these dimensions are manufacturing variables upon which the properties of the final call will depend. See Palmer, col. 3, lines 7 through 12. Palmer does not disclose a call with any feature allowing the user to vary dimensions to change the sound of a call. Moreover, as additional sound chambers are added to a call, the size of the call and the difficulty of carrying and using it becomes a problem, especially when a hunter wants to use the call while having a gun or bow at the ready.

U.S. Pat. No. 6,120,341 to Halford, discloses an arrangement very similar to Palmer's. Halford's call has a conventional reed call (1), onto which two additional chambers have been added, a “second middle baffle sound chamber” (2) and a “trombone-like third baffle or sound chamber” (3). The third sound chamber “may slide up and down the outer end of the second sound chamber varying the tone, pitch and volume of the call.” See Halford, Abstract. Like the trombone, upon which the Halford call is based, the user must slide the third sound chamber (3) in order to vary the call, but this is imprecise and requires more skill than a hunter may possess. Finally, as with Palmer, the additional sound chamber increases the size of the call, making it more cumbersome to carry and use.

Another problem with existing calls for larger game, such as elk, is that a long tube is required to create the appropriate sound, but the long tubes make the call awkward to carry and deploy. One example of an invention that attempts to make a large game call more portable is U.S. Pat. No. 4,335,539 to Jones, which includes adapters at either end of a flexible tube that, “when mated, form a convenient handle” (see Jones, Abstract), so that the working parts of the call are protected from debris and the call is made easier to carry. See Jones, col. 1, lines 33 through 35. But, the arrangement of Jones is limited to a game call consisting of only a flexible tube, whereas many calls, especially calls for larger game, such as elk, require a larger sound chamber, in addition to a simple tube chamber. Also, the Jones device must be held and carried by the user, even when in its storage position. This prevents the user from holding a gun or bow while carrying or using the call. Also, as with the Herter call, the Jones call relies exclusively on the user's skill in blowing through the whistle (20) and deforming the flexible tube to create accurate calls.

U.S. Pat. No. 7,234,987 to Brazil discloses a game call with a holding device that mounts the call to a hunter's garment. The disclosed mounting device includes a sleeve (3) that fits over the mouth piece (7) and a pin (5) to hold the assembly (10) to the hunter's (H) garment. As shown in Brazil's drawings, the pin can hold the call assembly to the hunter's shoulder or sleeve, allowing the hunter to blow into the call while drawing an arrow. The Brazil invention shows a relatively small game call and does not disclose any way to make the call more compact. In addition, like the Jones call, Brazil's mounting device works with a small, single chamber call and will not work with game calls that employ a larger sound chamber.

### SUMMARY OF INVENTION

What is needed is a game call that can change the tone, pitch and volume of a call in a simple and precise way.

Also needed is a large game call that can be made more compact and easier to carry. Also needed is a call that can be carried and used while leaving the user's arms and hands free to hold and deploy a gun or bow.

The present invention discloses a game call tone selector that provides a hunter with more control over the sounds produced. The present invention is especially useful for selecting a range of tones for calls to attract game such as elk, deer, and turkeys, but it may also be used with calls for other game. The invention provides a cap that fits over the end of a call's sound chamber, or “bugle tube”. The cap has a cone-shaped opening at its center, the narrow end of which extends into the bugle tube. The cap has a lip that fits over the rim of the bugle tube. The cap has one or more apertures disposed about the lip. The bugle tube has one or more complimentary apertures disposed about its lip. The apertures in the cap's lip may be aligned with the complimentary apertures in the rim of the bugle tube. By rotating the cap on the end of the bugle tube, the apertures can be fully aligned and open, partially aligned and restricted, or not aligned and blocked entirely. When the apertures are aligned, more air can flow out of the call and the tone of the call is lowered and the volume increased. When the apertures are partially aligned, one aperture only partly exposes the other aperture and less air can flow, so the tone rises and the volume decreases. When the apertures are not aligned, the cap covers the apertures in the bugle tube and no air can flow through these apertures, resulting in an even higher pitch as well as decreased volume from the bugle tube. Thus, the invention provides a game call that can change the tone, pitch and volume of a call in a simple and precise way.

The present invention also discloses an elongated, flexible tube that fits into one end of the bugle tube. The flexible tube can be pushed into the bugle tube for storage, thereby decreasing the size of the call and making it easier to carry. The flexible tube can be pulled out from this storage position to an operating position. Additionally, because the flexible tube can be bent, it is possible to hold the bugle tube under an arm and bend the smaller tube around to the user's mouth. A sling helps hold the bugle tube in place under the user's arm. No hands are necessary to hold the call in this position and, thus, it is possible for a hunter to use the call to attract game while simultaneously holding a gun or bow at the ready. In this way, the present invention provides a game call that can be made more compact and easier to carry while leaving the user's arms and hands free.

### BRIEF DESCRIPTION OF DRAWINGS

FIG. 1 is a three-quarter, cut-away view of the preferred embodiment of the game call of the present invention.

FIG. 2A is a cut-away, side view of the invention.

FIG. 2B is a cut-away, side view of a portion of the invention shown in FIG. 2A.

FIG. 3 is a three-quarter, rear view of the cap of the present invention.

FIG. 4 is a side view of the cap of the present invention.

FIG. 5 is a front view of the cap of the present invention.

FIG. 6 is a depiction of the invention in use.

### DETAILED DESCRIPTION OF SPECIFIC EMBODIMENTS

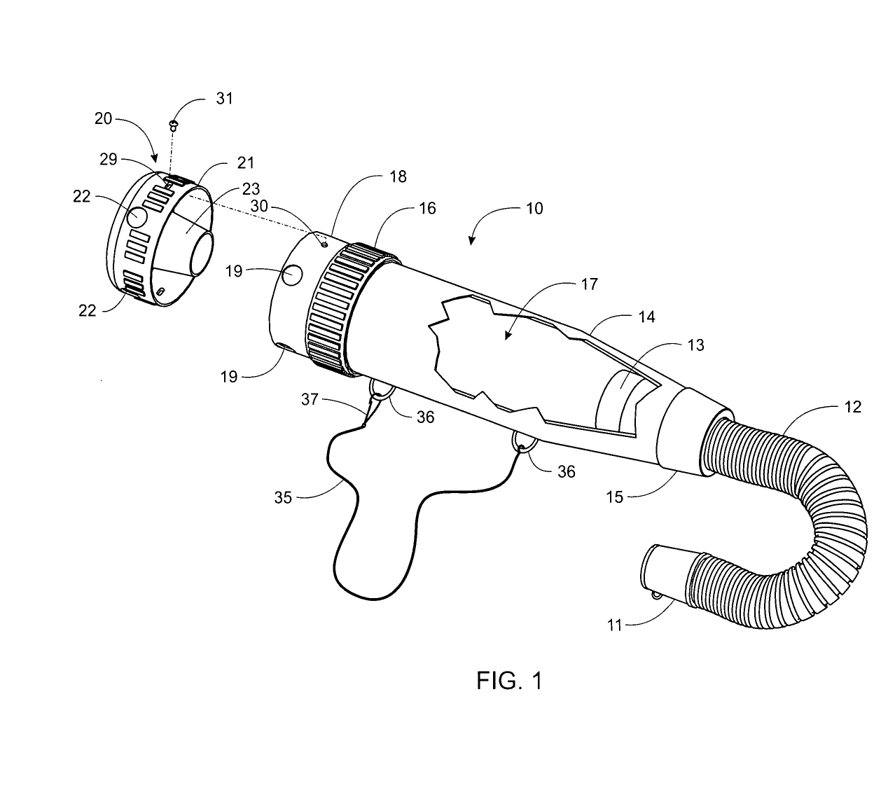

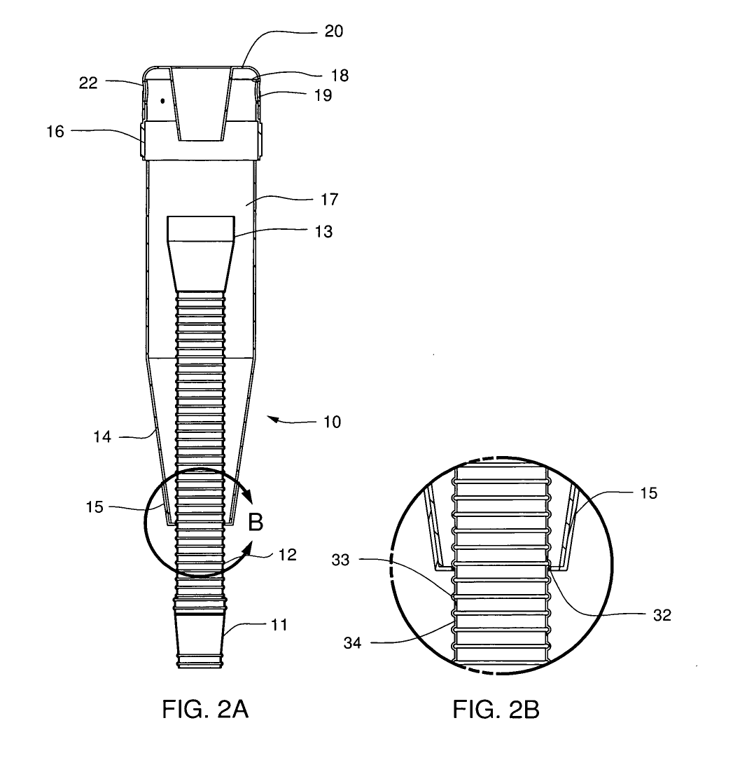

FIGS. 1 and 2A provide views of the preferred embodiment of elk calling system 10 of the present invention. The elk call used here for illustration has a mouth piece 11 connected to a length of flexible plastic tube or pipe 12, terminating in a small trumpet bell 13. In the embodiment shown here, the mouth piece 11 is vibrating reed type elk call, although other types of calls may be used. The air being blown through the mouth piece will create characteristic sounds. The flexible pipe 12 enters the smaller end 15 of a larger cylindrical tube 14, or bugle tube, that forms a sound chamber 17. The bugle tube 14 can be constructed plastic, which is light. A cap 20 covers the larger end 16 of the bugle tube 14, opposite the bugle tube's smaller end 15. As shown in FIG. 1, a sling 35 is provided so that the game call system 10 can be suspended from a person's shoulders. For illustrative purposes, the sling 35 shown in FIG. 1 is not long, but in practice, the sling 35 will be long enough to suit the user. For example, the sling 35 could be long enough to suspend the game call around a user's shoulders. The sling 35 connects to the bugle tube 14 at hooks 36 near the smaller end 15 and the larger end 16. A quick release clip 37 can also be provided at one end (as shown), or at both ends (not shown), to make it easy for the user to detach the call.

In FIG. 2A, the flexible pipe 12 is shown in a partially stored position, with most of the pipe 12 pushed inside the bugle tube's sound chamber 17. In the fully stored position, flexible pipe 12 is pushed as far as possible into the bugle tube's sound chamber 17. The smaller end 15 of the bugle tube 14 can be made of plastic and has an opening 32, the diameter of which is very slightly smaller than the diameter of the flexible plastic pipe 12. The flexible pipe 12 has an accordion-type structure, with ridges 33 and grooves 34. Because the pipe 12 is flexible, the ridges 33 can be pulled or pushed past the opening 32 of the smaller end 15 of the bugle tube, but the flexible pipe 12 will be held in place when the opening 32 comes to a rest in one of the grooves 34. Thus, the flexible pipe 12 can be held in place in a compact, stored position, as shown in FIG. 2A, or in an extended position, as shown in FIG. 1.

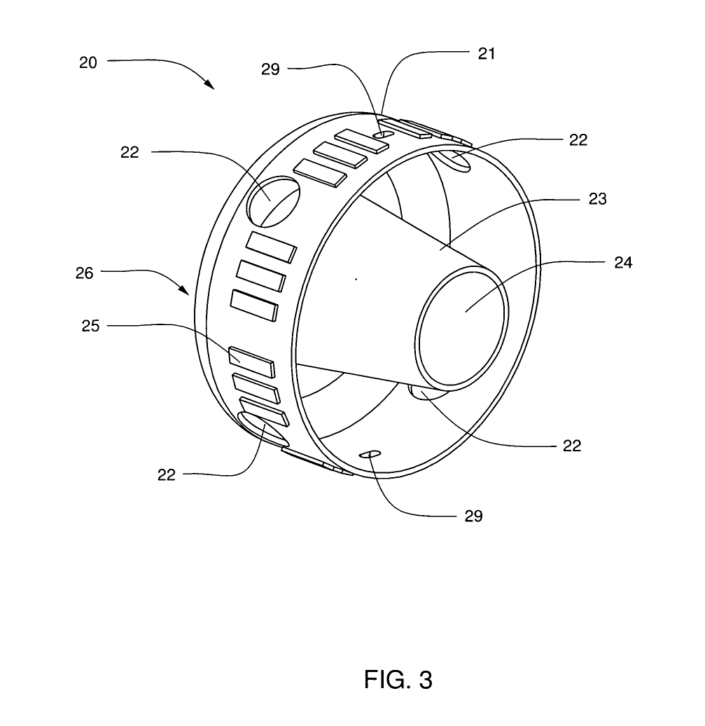

As shown in FIGS. 3 through 5, the cap 20 has an opening 27 at its center that includes a cone portion 23 that extends back into the bugle tube 17 (as shown in FIG. 2A). When vibrating air enters the small end 15 of the bugle tube's sound chamber 17 from the mouth piece 11 and through the flexible pipe 12, the vibrating air is pushed toward the large end 16 of the bugle tube chamber 17. The air is semi-trapped within the bugle tube's walls and the cap's cone-shaped opening 23, which allows certain amounts of air to escape through the cone's smaller end opening 24.

The cap 20 has a lip 21 that fits over the rim 18 (as shown in FIG. 1) of the large end 16 of the bugle tube 14. The cap 20 has holes 22 disposed about the lip 21 and these holes 22 align with similarly sized holes 19 (as shown in FIG. 1) compatibly disposed about the rim 18 of the bugle tube 14. In the preferred embodiment, four holes (19 and 22) are disposed at ninety degree intervals about the bugle tube's rim 18 and the cap's lip 21, respectively, and the holes have a diameter of about half an inch. The size and number of holes will have a significant effect on the sound produced. Persons of skill in the art of game calls will appreciate that the size and number of holes is a variable that will depend on the type of game call being produced. By rotating the cap 20 on the end of the bugle tube 14, the holes 22 in the cap's lip 21 can be aligned with the holes 19 on the bugle tube's rim 18, or they can be partially aligned, thereby decreasing the size of the holes' openings, or they can be out of alignment entirely, thereby covering the holes on the chamber. By covering or uncovering the holes, the tone of the call being produced can be selected by the user. Thus, the tone selector of the present invention has the function of being twisted to different positions to obtain different tones, pitches, and volume, thereby building back pressure, so the user has an easier time obtaining the notes desired.

The cap 20 is held onto the bugle tube 14, yet allowed to rotate, by means of one or more retaining screws 31 that extend through an oval-shaped aperture 29 in the cap's lip 21. The retaining screw threads into a hole 30 in the bugle tube's rim 18. The screw 31 is not forced down onto the cap's lip 21, but exerts only enough pressure to provide some friction to keep the cap 20 in a selected position. The oval-shaped aperture 29 allows the cap 20 to rotate enough to align the holes (19 and 22) or allow the cap's lip 21 to cover the bugle tube's holes 19. As seen in FIG. 1, the larger end 16 of the bugle tube 14 has ridges to help the user hold the bugle tube 14 while turning the tone selector cap 20. The cap 20 also has ridges 25, most clearly shown in FIGS. 3 through 5, provided for the same purpose.

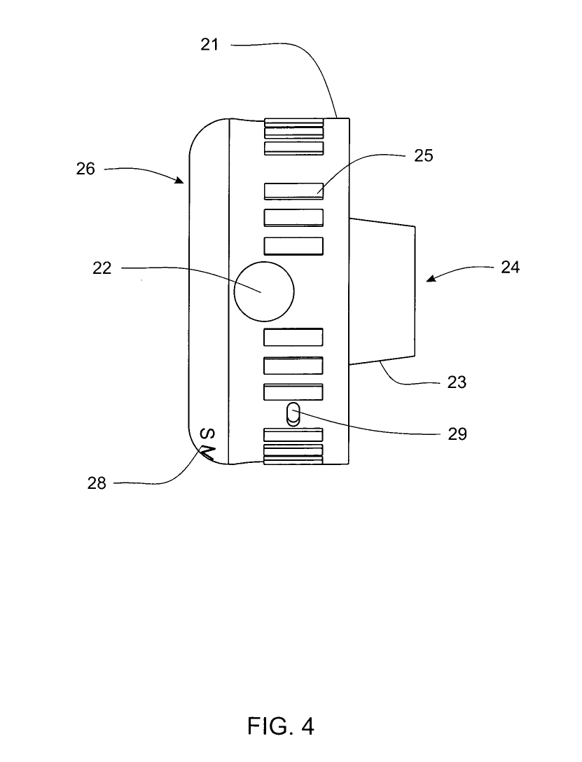

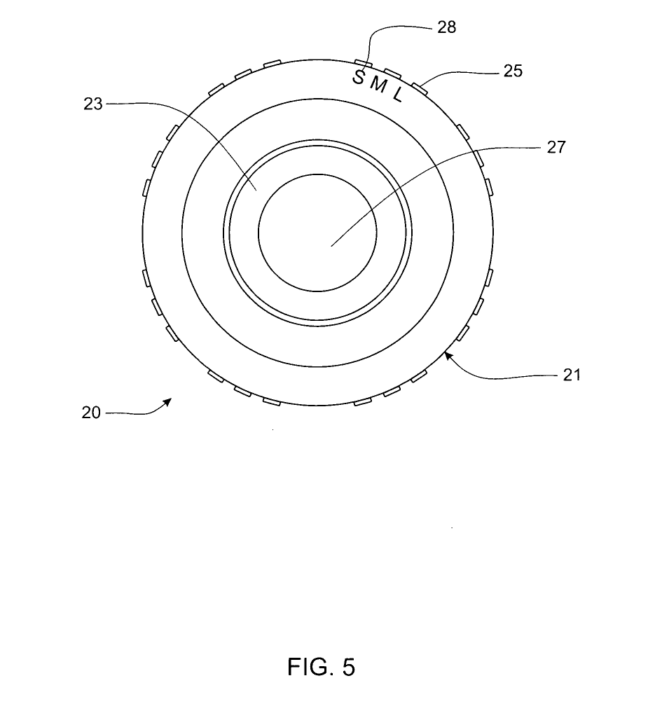

As shown in FIGS. 4 and 5, markings 28 on the front 26 of the cap 20 correspond to three alignment positions, thereby showing the user the position best suited to the type of call desired. Thus, when the tone selector cap 20 is twisted so that the holes (19 and 22) are not aligned and the openings are closed off, this will create more back pressure and change the pitch, tone and volume to a quieter, further away sound that imitates the sound of a young bull elk. The initial “S”, for “small bull”, can be put on the tone selector cap in association with this position 28, so that the user will know that this position creates a call that imitates, for example, the sound of a young bull elk. When the cap 20 is twisted so that the holes (19 and 22) in the cap's lip 21 and the bugle tube's rim 18 are aligned only half way, more air and sound can escape, relieving some back pressure, and, thereby, changing the tone, pitch, volume of the call. The resulting sound is deeper and louder. This call is associated with the sound of a medium-sized, or “satellite”, bull elk. The initial “M”, for “medium-sized bull”, can be put on the tone selector cap 20 in association with this position 28, so that the user will know that this position creates a call that imitates the sound of a medium-sized, satellite bull elk. When the cap 20 is twisted so that the holes (19 and 22) in the cap's lip 21 and the holes in the bugle tube's rim 18 are aligned, this will make the openings yet larger, allowing more air and sound to flow out, and changing the tone, pitch, and volume to a much deeper and louder sound, like the sounds of a herd or larger bull elk. Accordingly, the initial “L”, for “large bull”, can be put on the tone selector cap 20 in association with this position 28, so that the user will know that this position creates a call that imitates the sound of a large bull elk. People familiar with game calls will appreciate that this invention can be used in the same way with calls for other types of game.

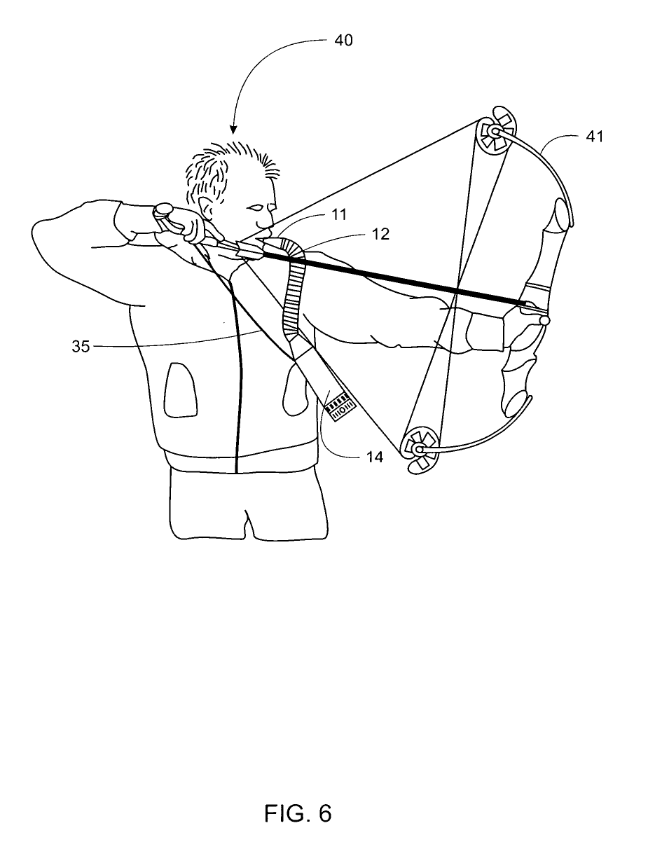

FIG. 6 shows an example of the invention in use by a hunter 40. The hunter 40 is holding a bow 41 in the drawn position, ready to let loose the arrow. The bugle tube 14 is suspended by its sling 35 over the hunter's shoulder. The flexible pipe 12 is in its extended position and can bend around and up so that the mouth piece 11 is at the hunter's mouth and a call can be made even while the bow is at the ready.

The drawings and description set forth here represent only some embodiments of the invention. After considering these, skilled persons will understand that there are many ways to make a game call according to the principles disclosed. The inventors contemplate that the use of alternative structures, materials, or manufacturing techniques, which result in a game call according to the principles disclosed, will be within the scope of the invention.

I claim:

1. A game call comprising:
a sound chamber having an inlet end and an outlet end and an interior space therebetween, said outlet end having a rim, and said rim having at least one rim aperture, and
a cap sized to fit over the rim of the outlet end of the sound chamber, said cap further having a periphery forming a lip, said lip being movable with respect to said rim, and said lip having at least one lip aperture arranged to align with said rim aperture and form an opening to said interior space when the movable cap is in a first position and form a smaller opening when the movable cap is in a second position.

2. The game call of claim 1 wherein the cap further comprises a front portion that is disposed over the outlet end of said sound chamber, and wherein the front portion of the cap further comprises an opening communicating with the interior space of the sound chamber.

3. The game call of claim 2 wherein the opening of the cap further comprises a trumpet bell extending into the interior space of the sound chamber.

4. The game call of claim 3 wherein the trumpet bell further comprises a larger end adjacent the front portion of the cap and a smaller end opposite to the larger end.

5. The game call of claim 1 further comprising a pipe having a mouth piece end, an opposite pipe end, and a flexible pipe stem between the mouth end and opposite pipe end, wherein the opposite pipe end is disposed within the interior space of said sound chamber and the flexible pipe stem extends through the inlet end of said sound chamber.

6. The game call of claim 5 wherein the opposite pipe end further comprises a trumpet bell disposed within the interior space of said sound chamber.

7. The game call of claim 5 wherein the flexible pipe stem is movable through the inlet end of the sound chamber so that at least most of the flexible pipe stem can be pushed into the interior space of said sound chamber.

8. The game call of claim 7 wherein the flexible pipe stem is an accordion-type flexible tube having ridges and grooves.

9. The game call of claim 8 wherein the inlet end of the sound chamber further comprises a retaining portal and wherein said retaining portal is sized slightly smaller than the ridges of the accordion-type flexible tube, and wherein said retaining portal is sized slightly larger than the grooves of the accordion-type flexible tube, so that retaining portal releasably secures said accordion-type flexible tube in a position at one of said grooves and between a pair of said ridges.

10. The game call of claim 1 wherein the cap further comprises indicia that the cap is in said first position.

11. The game call of claim 1 wherein the sound chamber further comprises a sling to suspend said sound chamber while being carried by a user.

12. A tone selector for a game call comprising:
a game call pipe having a mouth piece end, a length of flexible pipe connected to said mouth piece, and a sound exit end connected at an end of said flexible pipe opposite said mouth piece end,
a bugle tube comprising a sound entry aperture at a proximal end, an open distal end opposite said proximal end, and a sound chamber formed by one or more side walls between said proximal and distal ends, wherein the side wall or walls at said open distal end further comprise a rim portion, and wherein said rim portion further comprises at least one rim opening communicating with said sound chamber, and wherein said flexible pipe extends through the sound entry aperture of said bugle tube and the sound exit end of said game call pipe is disposed within the sound chamber of said bugle tube, and
a bugle tube cap disposed over the open distal end of said bugle tube, wherein the cap further comprises a lip sized to be movably received by the rim portion of said bugle tube, and wherein said lip further comprises a cap lip opening sized and disposed to align with the rim opening of said bugle tube when the rim and lip openings are in an open position, thereby allowing communication with the sound chamber of said bugle tube, and said rim and lip openings arranged to be moved to at least a partially unaligned position when the lip of said cap is moved to a second position, thereby restricting communication with the sound chamber through the at least partially unaligned position of said rim and lip openings, and wherein said cap further comprises a cap top located within said lip and over the open distal end of said bugle tube, wherein said cap top further comprises a cap aperture communicating with the sound chamber of said bugle tube.

13. The tone selector of claim 12 wherein the rim of said bugle tube is substantially cylindrical, and wherein the lip of said cap is sized to fit movably over said substantially cylindrical rim.

14. The tone selector of claim 12 wherein the cap aperture of said cap top further comprises an open conical structure formed by a larger opening at the cap aperture and a smaller opening opposite the larger opening, wherein the smaller opening of said conical structure is directed into the sound chamber of said bugle tube.

15. The tone selector of claim 12 further comprising gripping ridges disposed adjacent the rim of said bugle tube.

16. A compactable game call comprising:
a game call pipe having a mouth piece end, a length of flexible pipe connected to said mouth piece, and a sound exit end connected at an end of said flexible pipe opposite said mouth piece end,
a bugle tube comprising a sound entry aperture at a proximal end, a sound exit aperture at a distal end opposite said proximal end, and a sound chamber formed by one or more side walls between said proximal and distal ends, wherein said flexible pipe extends through the sound entry aperture of said bugle tube and the sound exit end of said game call pipe is disposed within the sound chamber of said bugle tube, and wherein the flexible pipe is movable through the sound entry aperture of the bugle tube so that at least most of the flexible pipe can be disposed within said sound chamber.

17. The compactable game call of claim 16 wherein the flexible pipe is a flexible tube having ridges and grooves.

18. The compactable game call of claim 17 wherein the sound entry aperture of the bugle tube further comprises a retaining portal and wherein said retaining portal is sized slightly smaller than the ridges of the flexible tube, and wherein said retaining portal is sized slightly larger than the grooves of the flexible tube, so that retaining portal releasably secures said flexible tube in a position at one of said grooves and between a pair of said ridges.
